(19) United States
(12) Patent Application Publication
(10) Pub. No.: US 2018/0127255 A1
(43) Pub. Date: May 10, 2018

(54) DRINK PRODUCING APPARATUS WITH FILLING LEVEL AND/OR VESSEL RECOGNITION DEVICE, HOUSEHOLD REFRIGERATION APPARATUS AS WELL AS METHOD FOR PRODUCING AND DISPENSING A DRINK

(71) Applicant: BSH HAUSGERAETE GMBH, MUENCHEN (DE)

(72) Inventors: KUDRET BAYSAL, GIENGEN BRENZ (DE); DELIA HAHN, HEIDENHEIM AN DER BRENZ (DE); MARCEL KIRSCHEN, GERSTHOFEN (DE); ANDREAS KLEINER, DORNSTADT (DE); CHRISTIAN MAYERSHOFER, GUNDREMMINGEN (DE); BERND METTEL, HERBRECHTINGEN (DE); CARSTEN WEISS, GIENGEN (DE)

(21) Appl. No.: 15/346,764

(22) Filed: Nov. 9, 2016

(51) Int. Cl. B67D 1/00; B67D 1/08; F25D 23/12; F25D 11/00; F25D 11/02

(52) U.S. Cl. CPC B67D 1/0016; B67D 1/0861; B67D 1/0882; F25D 11/02; B67D 1/0078; F25D 23/126; F25D 11/00; B67D 1/0894

(57) ABSTRACT

A drink producing apparatus includes: a dispensing unit for dispensing liquid from the drink producing apparatus, a dispensing container, which is formed for receiving a liquid addable to a drink by the drink producing apparatus, wherein the dispensing container is connected to the dispensing unit of the drink producing apparatus for leading the liquid from the dispensing container to the dispensing unit, and the dispensing unit comprises a dispensing opening, from which the liquid can be dispensed into a vessel, a vessel capturing unit for capturing at least one geometric parameter of the vessel. The invention also relates to a household refrigeration apparatus and to a method.

### TECHNICAL FIELD

The invention relates to a drink producing apparatus with a dispensing container, which is formed for receiving a liquid addable to a drink by the drink producing apparatus. The drink producing apparatus moreover includes a dispensing unit, to which the dispensing container is connected for supplying the liquid from the dispensing container to the dispensing unit. Furthermore, the invention also relates to a household refrigeration apparatus with such a drink producing apparatus as well as to a method for producing and dispensing a drink.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which has a drink apparatus, which is formed for dispensing a drink at this household refrigeration apparatus itself.

Moreover, cold drink machines are also known, in which alcohol containing mixed drinks, for example cocktails, can be dispensed.

In known drink producing apparatuses for dispensing cooled drinks, mixing of the liquid jet with other additions upon dispensing is restricted.

Especially carbonized and thus liquids mixed with carbonic acid lose carbonic acid in filling into the vessel, whereby the quality of the drink is decreased.

In known drink producing apparatuses, there also occurs the problem hat virtually any amount of liquid is dispensed and the user himself has to recognize when he has to terminate the dispensing. This often results in the fact that the termination is overlooked and thus overflow occurs. Thereby, the vessel is also wetted on the outside and gripping is unpleasant for a user. The vessel has to be cleaned and the hands are soiled. It can also result in the fact that the user frightens in overflow and jerkily pulls the vessel away, whereby tilting or drop down of the vessel can result. Further, especially with sparkling drinks, which have carbonized liquids, severe foaming occurs at the beginning, whereby the user is insecure whether or not the drink now overflows from the vessel. This can result in the fact that the user interrupts the dispensing multiple times, whereby filling is extended.

### PRESENTATION OF THE INVENTION

It is the object of the present invention to provide a drink producing apparatus as well as a household refrigeration apparatus as well as a method for producing a drink, by which or in which dispensing a drink is improved and overflow of the drink from the vessel is avoided.

This object is solved by a drink producing apparatus, a household refrigeration apparatus and a method according to the independent claims.

A drink producing apparatus according to the invention includes a dispensing container, which is formed for receiving a liquid addable to an in particular cooled drink by the drink producing apparatus. The drink producing apparatus moreover includes a dispensing unit, which is formed for dispensing the carbonized liquid or the mixed drink. The dispensing container is connected to the dispensing unit in fluid leading manner such that the carbonized liquid can be led from the dispensing container to the dispensing unit. The dispensing unit has a dispensing opening, from which the drink can be dispensed.

Moreover, the drink producing apparatus has a receiving device for receiving a vessel, wherein the carbonized liquid to be dispensed from the dispensing opening can be filled into the vessel.

The drink producing apparatus has a vessel capturing unit for capturing at least one geometric parameter of the vessel. Thereby, the dispensing of the liquid can be improved and matched with the vessel such that only such an amount of liquid is automatically dispensed, by which overflow from the vessel is avoided.

In a further aspect of the invention, the drink producing apparatus has a filling level capturing unit for automatically capturing a filling level of the drink in a vessel, into which the liquid can be dispensed. Thereby too, the dispensing of the liquid can be improved and matched with the vessel such that only such an amount of liquid is automatically dispensed, by which overflow from the vessel is avoided.

The drink capturing unit is formed to capture in particular a height of the vessel and/or a width of the vessel as a geometric parameter. With at least two different captured geometric parameters of the vessel, the vessel capturing unit is then also formed to determine at least two-dimensional, in particular three-dimensional information to the vessel. Thus, not only a shaping of the vessel in the two-dimensional can also be performed, but the three-dimensional shape of the vessel can also be determined. Thereby, it is also allowed to very exactly determine a receiving volume of the vessel. This in turn yields advantages to meter the dispensing of at least one liquid depending on situation such that overflow of the individual vessel is avoided.

The vessel capturing unit is preferably formed for non-contact detection of the at least one geometric parameter of the vessel. The vessel capturing unit can have at least one optical detector unit for optically capturing this at least one geometric parameter. For example, the optical detector unit can be an infrared detector unit.

The optical detector unit can have a first sensor unit, which is arranged in a first height position. The optical detector unit preferably has a second sensor unit, which is arranged in a second height position different from the first height position. By the sensor units, which are preferably formed as emitter-receiver units, light barriers are then formed. If a light beam of a sensor unit is incident on the vessel, thus, by reflection and/or scattering, specific reception or non-reception resulting therefrom is effected at the receiver of this sensor unit. Corresponding conclusions to the at least one geometric parameter of the vessel can then be drawn therefrom. This is possible both if the vessel is made of glass or else also of plastic or metal.

Advantageously, it is provided that a relative movement is allowed between a vessel and the detector unit such that certain movement in height direction and/or in width direction is allowed here too and thus a type of scanning of the vessel by the detector unit is virtually allowed. In the advantageous implementation, in which the detector unit has at least two sensor units arranged in different height positions, they can preferably be arranged directly above each other in vertical direction and thus be virtually positioned above each other on a fictive vertical connecting straight line.

Furthermore, it can be provided that the vessel capturing unit has at least one further optical detector unit for optically capturing at least one geometric parameter. Thereby, the possibility of providing even more exact detection of the vessel with respect to one or more geometric parameters is provided. This further optical detector unit too can preferably have a first sensor unit and at least one second sensor unit. These two sensor units are preferably arranged in a same height position viewed in vertical direction and then arranged spaced from each other on this horizontal plane. Thereby, the width of a vessel can be determined in particularly advantageous manner. In the second detector unit too, it is preferably provided that it is formed for non-contact capture of the geometric parameter and for example a sensor unit is here also formed as an emitter-receiver unit and formed for emitting and for receiving optical signals.

Especially in combination of a first optical detector unit and a second optical detector unit, thus, a matrix of sensor units can be provided, wherein here both multiple sensor units are then arranged one above the other in height direction, and multiple such sensor units are respectively arranged next to each other in width direction. Especially the capture of the shaping of a vessel is thereby particularly simply and highly precisely allowed. Since there are very different vessel shapes, for example a normal drinking glass, a sparkling wine glass, a cocktail glass, a beer glass, a whisky glass etc., very highly different volumes of these vessels also result. Especially if automatic filling of the vessel with the liquid and thus the drink to be produced and dispensed is desired and moreover corresponding overflow is to be avoided, the automatic stop of the dispensing is then also important and to be adapted to this corresponding configuration of the vessel. By capturing these different vessel shapes by the detector unit, the automatic dispensing and the stopping of the dispensing process can also be automatically effected much dependent on situation.

In a preferred implementation, the drink producing apparatus has a receiving device for receiving the vessel. The receiving device is preferably movable such that by the receiving device the vessel placed thereon can be lifted and/or tilted. Thereby, the relative position variation of the vessel to the detector unit can be effected without for example the detector unit having to be displaced. The scanning of the vessel is thereby simply and securely allowed.

It can also be provided that the drink producing apparatus has a position variation device, by which a position between the dispensing opening and the receiving device is variable. Thereby, defined vertical distances between the dispensing opening and for example a vessel bottom of the vessel or a surface of a liquid already filled into the vessel can be determined. Especially with carbonized liquids to be dispensed, this is a substantial advantage. Because thereby a vertical distance in this respect can be relatively small set. This has the advantage that upon impingement of the jet of the liquid dispensed from the dispensing opening, the jet height is relatively low and thus undesired hard impact and therefore extensive splash of the liquid again to the side resulting therefrom is avoided. By preventing that, undesired loss of carbonic acid from this liquid in this splashing apart is also avoided. The quality of the drink to be produced is thereby kept high.

In a further advantageous implementation, the drink producing apparatus has a filling level capturing unit, which is formed for automatically capturing a filling level of the drink in a vessel, into which the liquid can be dispensed. The filling level capturing unit can be constituted by the vessel capturing unit itself.

Furthermore, the invention also relates to a method for producing and dispensing a drink by a drink producing apparatus. Here, a dispensing container is provided, which is formed for receiving a liquid addable to a drink by the drink producing apparatus. Moreover, a dispensing unit of the drink producing apparatus is provided and connecting the dispensing container to the dispensing unit for leading the liquid from the dispensing container to the dispensing unit is performed. A vessel is placed on a receiving device of the drink producing apparatus. The vessel is captured and at least one geometric parameter of this vessel is determined. A jet of the at least one liquid is dispensed from the dispensing opening of the dispensing unit into the vessel. This is in particular effected depending on the at least one determined geometric parameter of the vessel. Thereby, much metered dispensing of the liquid with an amount of the drink matched therewith is performed depending on vessel and automatic stop of the dispensing process is allowed without overflow of the vessel occurring.

The vessel is at least two-dimensionally, preferably also three-dimensionally captured and there are preferably determined the shape of the vessel and therefrom the receiving volume of the vessel.

In an advantageous implementation, before starting the dispensing process, the vessel is brought in a placing position on the receiving device and moved upwards starting from the placing position. Thereby, relative movement between the vessel and the vessel capturing unit is effected. In upwards moving, the capture of the vessel for determining the at least one geometric parameter of the vessel is performed. In a basic position of the vessel then reached in upwards moving relative to the dispensing opening, the above already mentioned vertical distance or reference distance between the reference location of the vessel, for example a vessel bottom, if liquid is not yet filled into the vessel, or a surface of a liquid already filled into the vessel to the dispensing opening is then also set. This vertical distance is then preferably kept constant during the dispensing process.

Advantageously, in upwards moving the vessel, an upper border of the vessel is further upwards moved by a then still defined vertical path in moving through a light barrier of the vessel capturing unit topmost in vertical direction. By this additional upwards moving, especially if the vessel capturing unit is also a filling level capturing unit, it is achieved that overflow is securely prevented in a subsequent dispensing process. Because if the filling level is then reached in filling, which is then detected by the topmost light barrier, the dispensing process is terminated, and since this maximum upper filling level is further down than the upper border of the vessel due to the defined vertical path further upwards moved, this overflow of the drink from the vessel is securely prevented.

Preferably, it is provided that the drink producing apparatus has a capsule with an addition medium separate from the dispensing container, which can then be added to the jet of the liquid in producing the mixed drink. Such an addition medium can be liquid, gelatinous or powdery. In this context, addition media individual both in taste and in color can then be present, which impart corresponding specifications to the mixed drink.

In particular, it is provided that the drink producing apparatus has at least one second dispensing container, which is formed for receiving a second liquid addable to the in particular cooled mixed drink by the drink producing apparatus, wherein this second dispensing container is connected to the dispensing unit of the drink producing apparatus for leading the second liquid from the second dispensing container to the dispensing unit, wherein the first liquid and the second liquid are mixed to the jet dispensed from the dispensing opening. In this configuration, thus, a mixed drink of two different liquids is already present at the dispensing opening, which can then in particular be mixed with the jet of the addition medium from the capsule.

It can be provided that a liquid, in particular the first liquid, is water or contains water and the second liquid is alcohol or contains alcohol.

In particular, the two liquids also have different freezing points.

In particular, the first dispensing container is cooled by a cooling device of the drink producing apparatus. The cooling device is in particular a refrigeration circuit. The refrigeration circuit in particular includes an evaporator thermally coupled to the dispensing container such that the dispensing container can be cooled by the cold energy of the evaporator and thus the first liquid in particular present in the dispensing container is then also cooled thereby.

In particular, the preferably present second dispensing container can also be cooled by the cooling device. Here too, the thermal coupling to a refrigeration circuit is in particular provided, which is preferably the refrigeration circuit, by which the first dispensing container is also cooled. Here too, it is preferably provided that the second dispensing container is thermally coupled to an own, separate evaporator and is cooled via the cold energy thereof. Especially if the two liquids have different freezing points, the cooling with separate cooling units, in particular separate evaporators, is advantageous to be able to individually adjust adequate temperatures without one of the two liquids freezing.

Furthermore, the invention also relates to a household refrigeration apparatus for storing and preserving food, which has a housing, in which a receiving space for food is formed. The household refrigeration apparatus moreover includes a drink producing apparatus according to the first independent aspect of the invention or according to the second independent aspect of the invention. The household refrigeration apparatus can be a refrigerator or a freezer or a combined refrigerator-freezer.

In addition, it can also be provided that the drink producing apparatus is formed for receiving a capsule, in which additives, which can be added to the mixed drink, are contained. Additives can be powdery or gelatinous or also liquid. In this context, the capsule can then be introduced into a dispensing area of the drink producing apparatus and this ingredient of the capsule can then also be automatically dispensed or admixed or already be admixed upon dispensing the mixed drink.

In an advantageous implementation, it is provided that the drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the drink producing apparatus is accessible on the front side and exposed and not closed and covered by a door.

In an advantageous implementation, it is provided that the drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

Furthermore, the invention also relates to a method for producing a drink by a drink producing apparatus, wherein providing a dispensing container, which is formed for receiving a liquid addable to a drink by the drink producing apparatus, is effected. A dispensing unit of the drink producing apparatus is provided and connecting the dispensing container to the dispensing unit for leading the liquid from the dispensing container to the dispensing unit is effected. A vessel is placed on a receiving device of the drink producing apparatus. Capturing the vessel and determining at least one geometric parameter of the vessel is effected. Dispensing a jet of the at least one liquid from a dispensing opening of the dispensing unit into the vessel is performed, in particular depending on the at least one determined geometric parameter.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of partial components of an embodiment of a drink producing apparatus according to the invention as it can be installed in the household refrigeration apparatus according to FIG. 1;

FIG. 3 a schematic side view of partial components of an embodiment of a drink producing apparatus according to the invention;

FIG. 4 a schematic plan view of partial components of an embodiment of a drink producing apparatus according to the invention; and

FIG. 5 a schematic side view of partial components of a further embodiment of a drink producing apparatus according to the invention.

### PREFERRED EMBODIMENTS OF THE INVENTION

In the figures, identical or functionally identical elements are provided with the same reference characters.

In the figures, identical or functionally identical elements are provided with the same reference characters.

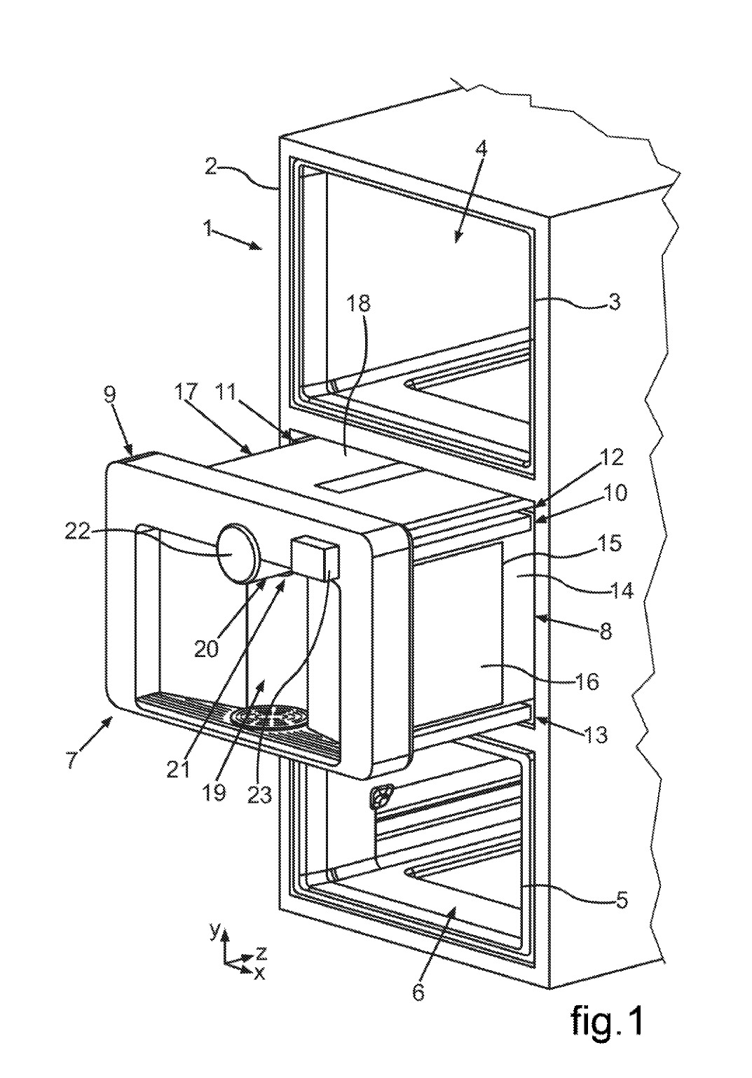

In FIG. 1, an embodiment of a household refrigeration apparatus 1 is illustrated in certain areas in a simplified perspective representation. Here, the household refrigeration apparatus 1 is for example a combined refrigerator-freezer, but can also be only a refrigerator or a freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a drink producing apparatus 7, which is a mixed drink producing apparatus in the embodiment.

However, the drink producing apparatus 7 can also be formed as a separate independent apparatus and thus be installed independently of a household refrigeration apparatus 1 and operable independently thereof.

The mixed drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The drink producing apparatus 7 is disposed accessible from the front side and thus from the front and the visible side. In particular, it is not closable and thus not coverable on the front side by a door.

The drink producing apparatus 7 has a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown. However, the apparatus 7 can also be disposed fixedly installed.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the drink producing apparatus 7 is advantageously displaceably supported in the interior container 8. Advantageously, the displacing device 10 also has an extraction stop, by which the drink apparatus formed in particular as a drink producing apparatus 7 is secured in position in a completely extracted position shown in FIG. 1. Thus, over-extraction cannot be effected such that the drink producing apparatus 7 cannot fall out to the front and tilt downwards, respectively.

Advantageously, it is also provided that the displacing device 10 has a displacing protection, by which the drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead, a magnetic mount can for example also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead, it can also be provided that a corresponding access is formed at an opposing further vertical sidewall 17 and/or at least one such access 15 is formed at a ceiling wall 18 of the housing 9.

Moreover, the drink producing apparatus 7 includes a recess or placing bay 19 on the front side, into which a drinking vessel can be placed, by which the mixed drink to be produced and dispensed by the drink producing apparatus 7 can then be collected. The drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can additionally be admixed to this mixed drink to be produced, which can be produced and thus mixed from at least two different liquids. Thereto, it can in particular be provided that a capsule receptacle 22 is formed, into which a capsule having the mentioned additive or an addition medium can be inserted. Upon dispensing the mixed drink, this ingredient or additive is then removed from the capsule and added to the mixed drink in particular after dispensing into the drinking vessel effected via the dispensing opening 21.

Moreover, it can in particular be provided that the drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the drink producing apparatus 7 has a cartridge for admixing carbon dioxide into the mixed drink. Thereto, the accessibility for cartridge exchange is allowed via at least one present access 15. In an advantageous implementation, it is provided that the drink producing apparatus 7 is connected to a water connection external to household apparatus such that supply of water is for example allowed via a house water network. This has the additional advantage that a liquid to be added to the mixed drink as water does not have to be stored in a largely dimensioned container in the drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the drink producing apparatus 7, but additionally or instead can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the drink producing apparatus 7, or by a carbonized second liquid, which is then present in the second container.

It is in particular provided that the drink producing apparatus 7 has a first container, in which a first liquid with a first freezing point, in particular water, is then provided or stored to then provide it for producing and dispensing a mixed drink depending on demand. Moreover, the drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

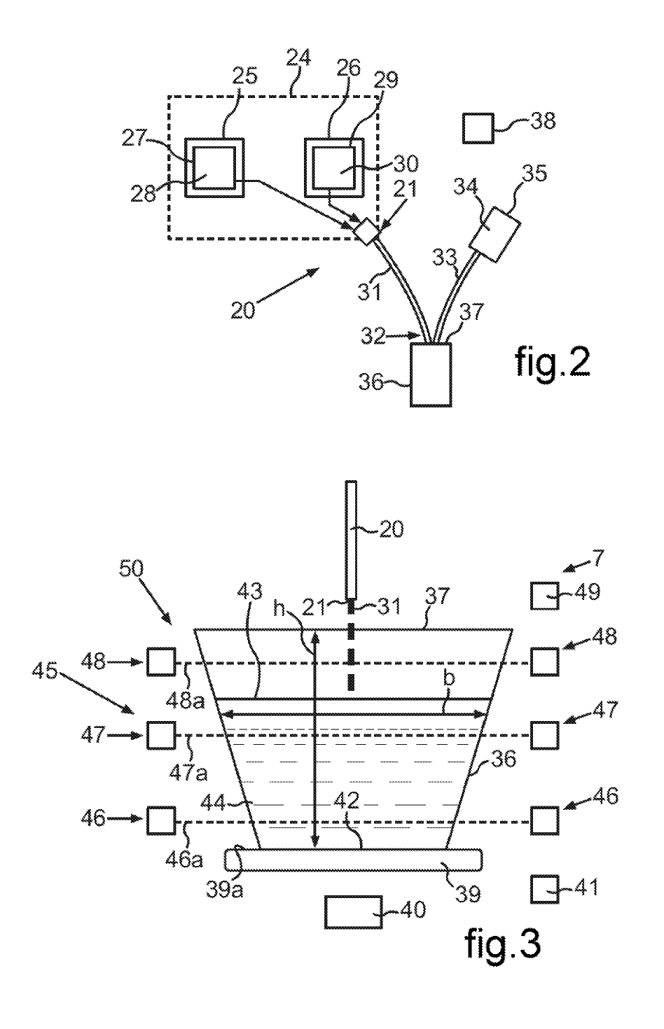

In FIG. 2, the household refrigeration apparatus 1 is shown with partial components of the drink producing apparatus 7 in a schematic representation. The household refrigeration apparatus 1 includes a refrigeration circuit 24, which is in particular a refrigeration circuit of the drink producing apparatus 7. In an advantageous implementation, this refrigeration circuit 24 includes a non-illustrated condenser, a compressor as well as a first evaporator 25 and a second evaporator 26 separate therefrom. The mixed drink producing apparatus 7 includes a first container or dispensing container 27, which is formed for receiving the first liquid 28 addable to the mixed drink, in the embodiment. The first dispensing container 27 is thermally coupled to the refrigeration circuit 24, in particular thermally coupled to the first evaporator 25. In an advantageous implementation, the first evaporator 25 surrounds the first dispensing container 27 on the outer side thereof at least in certain areas.

In the embodiment, it is provided that the drink producing apparatus 7 has a second container or dispensing container 29 separate from the first dispensing container 27, which is formed for receiving a second liquid 30 different from the first liquid, which can also be added to the mixed drink. Here too, it is preferably provided that the second evaporator 26 is thermally coupled to the second dispensing container 29, in particular surrounds it on the outer side thereof at least in certain areas.

In particular, it is provided that the first liquid 28 is or has water and the second liquid 30 is or contains alcohol.

In FIG. 2, dispensing of the two liquids 28 and 30 from the dispensing containers 27 and 29 is then illustrated by arrows in sketchy manner in the schematic representation, and the two liquids 28 and 30 are mixed to a common liquid jet 31 in an advantageous implementation. However, dispensing of a jet of only one of the two liquids 28 and 30 can also be provided.

In particular, it is provided that the jet 31 is formed after exit from the dispensing opening 21 at a place of meeting 32 with a jet 33 of an additive or addition medium 34, which is contained in a capsule 35 disposed in the mixed drink producing apparatus 7, after the dispensing opening 21, but before entry into a receiving vessel 36 with regard to the height position viewed in vertical direction. In particular, this place of meeting 32 is above a border 37 of the receiving vessel 36 in vertical direction. Mixing between the jet 31 and the jet 33 then desirably improved already before entry into the receiving vessel 36 is thereby achieved.

Therein, the receiving vessel 36 is placed in the placing bay 19 (FIG. 1).

The drink producing apparatus 7 also includes a control unit 38 for controlling the dispensing of the mixed drink.

In FIG. 3 a representation of partial components of the drink producing apparatus 7 is shown in a schematic side view. Here, it is apparent that a receiving device 39 is formed, on which the vessel 36 is placed. The receiving device 39 can have a flat surface 39a, on which this vessel 36 is placed. However, a well can for example also be formed on this top side 39a, into which the vessel 36 is placed for securely positioning.

In the embodiment, the drink producing apparatus 7 has a position variation device 40, by means of which the receiving device 39 can be moved. In particular, lifting and lowering in vertical direction is here allowed. It can also be provided that tilting is allowed such that the vessel 36 can be arranged slanted to the dispensing opening 21.

Preferably, the drink producing apparatus 7 also has a distance setting device 41, by which a vertical distance between a vessel bottom 42 of the vessel 36 and the dispensing opening 21 (at the beginning of the dispensing process, where liquid is not yet in the vessel 36) or then between a surface 43 of the liquid 44 already filled into the vessel 36, which then represents the drink, and the dispensing opening 21 (when the dispensing has started) can be set in defined manner. This distance can then be kept constant during the dispensing process of the drink and thus also the liquid 28 and/or 30.

Thereto, a relative movement between the dispensing opening 21 and the vessel 36 is effected depending on the already reached filling level of the vessel 36. At the beginning of the dispensing process, liquid 44 is not yet present in the vessel 36 such that the distance between the dispensing opening 21 and the vessel bottom 42 is then set as this vertical distance further to be kept constant in this respect.

The drink producing apparatus 7 moreover has a vessel capturing unit 45. It is formed for capturing at least one geometric parameter of the vessel 36. The vessel capturing unit 45 is formed for capturing a height h and a width b. In particular, the vessel capturing unit 45 is also formed for capturing a depth, which extends perpendicularly to the figure plane in FIG. 3. The capture of the vessel 36 can therefore be both two-dimensionally and three-dimensionally effected. Thereby, the shape of the vessel 36 can also be two-dimensionally and three-dimensionally determined.

In the embodiment, the vessel capturing unit 45 has multiple sensor units, wherein a first sensor unit 46, a second sensor unit 47 and a third sensor unit 48 are here for example formed. The sensor units 46 to 48 are arranged in different height positions in FIG. 3. They are each formed as an emitter-receiver unit. The sensor units 46 to 48 are formed for non-contact detection of at least one geometric parameter of the vessel 36. In particular, they are components of an optical detector unit, in particular of an infrared detector unit. The number of the sensor units 46 to 48 can also be more than three or else only two.

By a relative movement between the vessel 36 and the sensor units 46 to 48, this at least one geometric parameter can be captured and determined. Thus, scanning of the vessel 36 is virtually performed.

In the example according to FIG. 3, the width b viewed over the height h is not constant, but this vessel 36 expands in funnel-like manner to the top. This shaping too is captured by the vessel recognition unit 45. Thereby, the volume of the vessel 36 can then also be determined, whereby the possibility of determining a corresponding receiving amount of the vessel 36 and thus dispensing an amount of drink then much dependent on situation via the dispensing unit 20 again arises.

In the embodiment according to FIG. 3, light beams with main emission directions 46a, 47a and 48a of the sensor units 46 to 48 are generated in horizontal direction such that a raster of horizontal light barriers is here formed.

The drink producing apparatus 7 in particular also has a filling level capturing unit 49, which is symbolically illustrated in FIG. 3. In the embodiment in FIG. 3, it is provided that the filling level capturing unit 49 is not a unit separate from the vessel capturing unit 45, but is constituted by this vessel capturing unit 45.

In an advantageous implementation, in producing and dispensing a drink via the drink producing apparatus 7, the liquid 28 and/or the liquid 30 are filled into the provided dispensing containers 27 and 29. Depending on the desired drink to be produced and to be dispensed, the liquid 28 and/or the liquid 30 are dispensed via the dispensing unit 20 connected to the dispensing containers 27 and 29 when the dispensing process is started. Before this dispensing, the vessel 36 is placed in the recess or placing bay 19 and in particular on the preferably present receiving device 39. Then, at least one geometric parameter of the vessel 36 is captured as it was already explained above. Thereto, it is in particular provided that the receiving device 39, if it is movable, is taken into a placing position moved downwards. Then, the vessel 36 is placed on this receiving device 39 such that the vessel 36 has also occupied the placing position. Furthermore, the receiving device 39 is then preferably moved upwards in the direction to the dispensing unit 20 via the position variation device 40. Therein, the at least one geometric parameter of the vessel 36 is determined by the vessel capturing unit 45.

In particular, the vessel 36 is moved up to the upper light barrier, which is constituted by the upper sensor unit 48 in the shown embodiment. If the upper border 37 of the vessel 36 is captured by the uppermost sensor unit 48, further upwards movement of the vessel 36 is preferably effected over a defined vertical path. This defined vertical path can for example be less than 2 cm and greater than 0.5 cm such that a vertical distance between the upper border 37 and the uppermost sensor unit 48 is less than 2 cm, for example 1 cm, in this basic position.

In this basic position then reached, a defined vertical distance between the dispensing opening 21 and the vessel bottom 42 is preferably also further set. In the following dispensing process, this distance between the dispensing opening 21 and the reference location of the vessel 36 is kept constant. This means that in starting the dispensing process, this vertical distance is then not successively determined between the vessel bottom 42 and the dispensing opening 21, but is measured between the dispensing opening 21 and the then respectively reached dynamic filling level and thus the surface 43 of the liquid 44 then respectively already filled into the vessel 36. Thus, the height of fall of the jet 31 between the dispensing opening 21 and the reference location of the vessel 36 is constant over the entire dispensing process.

In this then started dispensing process, the vessel 36 is dynamically downwards moved, wherein this is depending on the filling level, in particular depending on the vertical distance then respectively to be kept constant between the dispensing opening 21 and the filling level or the surface 43.

When the surface 43 then reaches the uppermost sensor unit 48 during this dispensing process, the dispensing process is automatically stopped. Especially in this implementation, it is then advantageous if the vessel capturing unit 45 also has the function of the filling level capturing unit 49 at the same time.

In the configuration according to FIG. 3, the sensor units 46, 47 and 48 are arranged in different height positions and also positioned on a common vertical connecting straight line viewed in vertical direction. The sensor units 46 to 48 are also arranged such that the light beams as the optical signals each have own main emission directions 46a, 47a and 48a, which are horizontally oriented in the embodiment. As is apparent in FIG. 3 thereto, these main emission directions are then oriented parallel to each other.

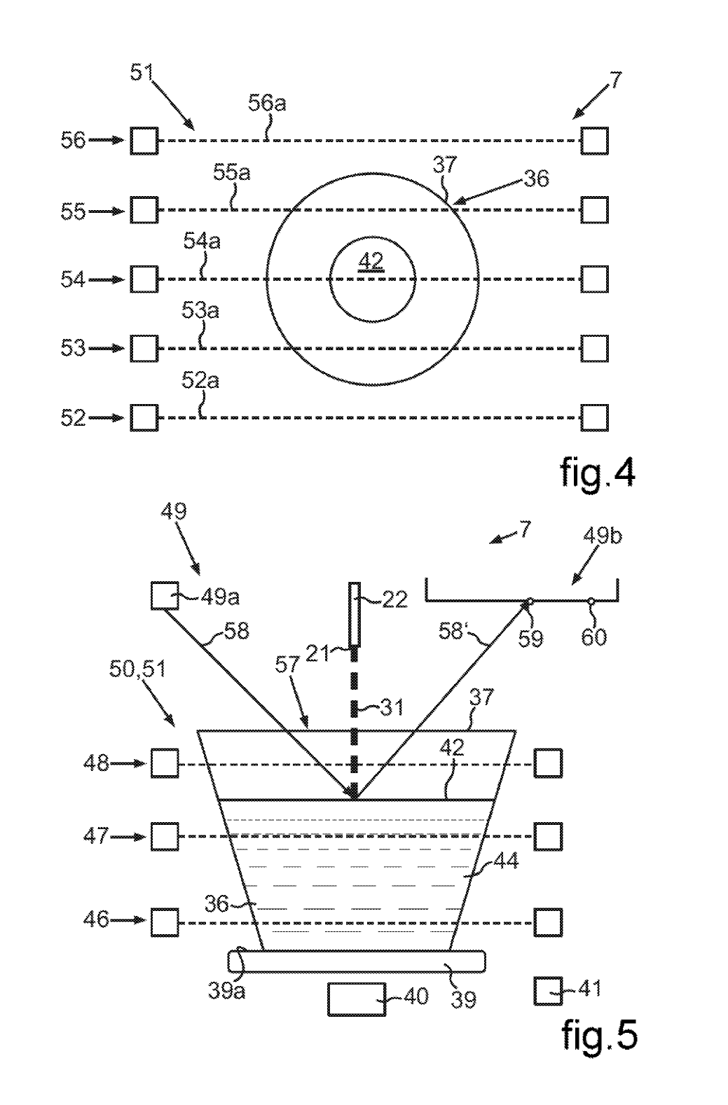

The first optical detector unit 50 explained to FIG. 3, which has sensor units 46, 47 and 48 only to be exemplarily understood in number and position, can additionally also be supplemented. Thereto, a schematic plan view representation is shown in FIG. 4. In this implementation, the drink producing apparatus 7 has a further detector unit 51, which is preferably also an optical detector unit. In FIG. 4 it is looked to the vessel 36 from above such that it is virtually seen into the interior of the vessel 36. The further detector unit 51 also preferably has a plurality of sensor units, wherein sensor units 52, 53, 54, 55 and 56 are here exemplarily illustrated. These sensor units 52 to 56 are preferably formed as infrared sensor units and preferably each have an emitter-receiver unit. Here, light beams with their main emission directions 52a, 53a, 54a, 55a and 56a are then again emitted, wherein the respective main emission directions of these optical signals are again symbolically represented here too. These main emission directions 52a to 56a are again parallel such that a certain optical raster is formed here too. By this further detector unit 51, the geometric parameter of the width b of the vessel 36 is in particular determined. The sensor units 52 to 56 shown in FIG. 4 are all arranged in the same height position and arranged next to each other and spaced from each other in this respect. The further detector unit 51 can also be present alone, but is preferably provided in combination with the detector unit 50. Especially if at least one further sensor unit, as they are constituted by the sensor units 46 to 48 of the detector unit 50, are respectively arranged below the sensor units 52 to 56 respectively viewed in height direction, a matrix-like arrangement of sensor units in width direction and in height direction is formed such that a highly functional three-dimensional scanning structure is generated. An extensive and precise capture of the vessel 36 is thereby allowed. With complex shapings of the vessel 36, exact determinations of multiple geometric parameters and/or the shape of the vessel 36 can thereby be determined and then a respectively individually possible filling amount can thereby be determined.

In the implementations according to FIG. 3 and FIG. 4, it is provided that the vessel capturing unit 45 and the filling level capturing unit 49 are formed for respective detection through the vessel 36. Preferably, the determined geometric parameters are compared to stored reference parameters and the shape of the vessel is determined depending thereon. Hereto, a table can preferably be recorded in a memory, in particular a memory of the control unit 38 such that the respective association with respect to the vessel recognition can here be very fast effected.

The determination of the volume of the vessel 36 can also be effected or estimated based on a recorded reference table.

In FIG. 5, a further embodiment of a drink producing apparatus 7 is shown in a schematic representation. In this implementation, the vessel capturing unit 45 is formed separately from the filling level capturing unit 49. Here, the filling level capturing unit 49 is preferably arranged in position such that the surface 43 of the already filled liquid 44 is captured directly from above. Thereto, a signal is emitted by an emitter 49a, which is incident on the surface 43 through a filling opening 57 of the vessel 36. Preferably, the filling level capturing unit 49 is formed with at least one ultrasonic sensor in this implementation, which is constituted by the emitter 49a. Therein, the emitted signal 58 is radiated to the surface 43 at an angle to the jet 31 and correspondingly reflected on this surface 43. Moreover, the filling level capturing unit 49 includes a receiver 49b, on which the reflected beam 58′ is then incident. Depending on the respectively reached filling level and a dynamic variation of the distance between the emitter 49a and the receiver 49b to the surface 42 resulting therefrom, this angle of incidence and thus also the angle of reflection vary such that a place of incidence 59 of the reflected beam 58′ at the receiver 49b continuously varies in this respect. By the increasing filling level in the vessel 36, the angle of incidence of the beam 58 becomes larger and thus the angle of reflection of the reflected beam 58′ also becomes larger such that upon reaching a place of incidence 60, which is correspondingly farther outwards, a measure is defined, beyond which the filling level is not to extend. If the reflected beam 58′ then is incident on the receiver 49b at this place of incidence, thus, the desired maximum filling, at which overflow of the vessel 36 is specifically avoided, is reached. Here too, the corresponding setting can then again be effected such that this filling level maximally to be reached is offset downwards to the upper border 37 of the vessel 36 in a certain defined distance. Here, a corresponding distance can for example be set less than 2 cm and greater than 0.5 cm, for example 1 cm. For example, the receiver 49b can be a multi-segment detector, for example a CMOS detector. Here, a digital camera can for example also be provided as the receiver 49b.

### LIST OF REFERENCE CHARACTERS

1 Household refrigeration apparatus
2 housing
3 interior container
4 first receiving space
5 interior container
6 second receiving space
7 mixed drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 refrigeration circuit
25 first evaporator
26 second evaporator
27 first dispensing container
28 first liquid
29 second dispensing container
30 second liquid
31 jet
32 place of meeting
33 jet
34 addition medium
35 capsule
36 vessel
37 border
38 control unit
39 receiving device
39a surface
40 position variation device
41 distance setting device
42 vessel bottom
43 surface
44 liquid
45 vessel capturing unit
46 sensor unit
46a main emission direction
47 sensor unit
47a main emission direction
48 sensor unit
48a main emission direction
49 filling level capturing unit
49a emitter
49b receiver
50 detector unit
51 detector unit
52 sensor unit
52a main emission direction
53 sensor unit
53a main emission direction
54 sensor unit
54a main emission direction
55 sensor unit
55a main emission direction
56 sensor unit
56a main emission direction
57 filling opening
58 signal
58′ beam
59 place of incidence
60 place of incidence
b width
h height

1. Drink producing apparatus comprising:
a dispensing unit for dispensing liquid from the drink producing apparatus,
a dispensing container, which is formed for receiving a liquid addable to a drink by the drink producing apparatus, wherein
the dispensing container is connected to the dispensing unit of the drink producing apparatus for leading the liquid from the dispensing container to the dispensing unit, and
the dispensing unit comprises a dispensing opening, from which the liquid can be dispensed into a vessel,
a vessel capturing unit for capturing at least one geometric parameter of the vessel.

2. Drink producing apparatus according to claim 1, wherein the vessel capturing unit comprises at least a first optical detector unit for optically capturing at least one geometric parameter.

3. Drink producing apparatus according to claim 2, wherein the first optical detector unit comprises a first sensor unit, which is arranged in a first height position, and comprises at least one second sensor unit, which is arranged in a second height position, wherein the second height position is different from the first height position.

4. Drink producing apparatus according to claim 3, wherein the first sensor unit and the second sensor unit are positioned such that they are arranged on a vertical connecting straight line.

5. Drink producing apparatus according to claim 3, wherein the first sensor unit is formed for emitting an optical signal and comprises a first main emission direction of this optical signal, and the second sensor unit is formed for emitting an optical signal and comprises a second main emission direction of this optical signal, wherein the two main emission directions are parallel.

6. Drink producing apparatus according to claim 1, wherein the vessel capturing unit comprises at least one second optical detector unit for optically capturing at least one geometric parameter of the vessel.

7. Drink producing apparatus according to claim 6, wherein the second optical detector unit comprises a first sensor unit and at least one second sensor unit, wherein the first sensor unit and the second sensor unit are arranged in a same height position and are arranged spaced next to each other in this height position.

8. Drink producing apparatus according to claim 7, wherein the first sensor unit is formed for emitting an optical signal and this optical signal comprises a first main emission direction, and the second sensor unit is formed for emitting an optical signal and this optical signal comprises a second main emission direction, wherein the two main emission directions are parallel.

9. Drink producing apparatus according to claim 1, wherein a geometric parameter is a height of the vessel.

10. Drink producing apparatus according to claim 1, wherein a geometric parameter is a width or a depth of the vessel.

11. Drink producing apparatus according to claim 1, wherein a geometric parameter is an at least 2-dimensional shape of the vessel.

12. Drink producing apparatus according to claim 1, comprising:
a receiving device for receiving the vessel, and
a position variation device, by which a position between the dispensing opening and the receiving device is variable.

13. Drink producing apparatus according to claim 1, comprising:
a filling level capturing unit for automatically capturing a surface of a liquid filled into the vessel.

14. Drink producing apparatus according to claim 13, wherein the filling level capturing unit is constituted by the vessel capturing unit.

15. Drink producing apparatus according to claim 13, wherein the filling level capturing unit is formed for capturing the filling level in the vessel through the material of the vessel.

16. Drink producing apparatus according to claim 13, wherein the filling level capturing unit is formed for capturing the filling level through a filling opening of the vessel.

17. Drink producing apparatus comprising:
a dispensing unit for dispensing liquid from the drink producing apparatus,
a dispensing container, which is formed for receiving a liquid addable to a drink by the drink producing apparatus, wherein
the dispensing container is connected to the dispensing unit of the drink producing apparatus for leading the liquid from the dispensing container to the dispensing unit, and
the dispensing unit comprises a dispensing opening, from which the liquid can be dispensed into a vessel,
a filling level capturing unit for automatically capturing a surface of a liquid filled into the vessel.

18. Household refrigeration apparatus comprising a housing, in which a receiving space for food is formed, and a drink producing apparatus comprising:
a dispensing unit for dispensing liquid from the drink producing apparatus,
a dispensing container, which is formed for receiving a liquid addable to a drink by the drink producing apparatus, wherein
the dispensing container is connected to the dispensing unit of the drink producing apparatus for leading the liquid from the dispensing container to the dispensing unit, and
the dispensing unit comprises a dispensing opening, from which the liquid can be dispensed into a vessel,
a vessel capturing unit for capturing at least one geometric parameter of the vessel.

19. Household refrigeration apparatus comprising a housing, in which a receiving space for food is formed, and a drink producing apparatus comprising:
a dispensing unit for dispensing liquid from the drink producing apparatus,
a dispensing container, which is formed for receiving a liquid addable to a drink by the drink producing apparatus, wherein
the dispensing container is connected to the dispensing unit of the drink producing apparatus for leading the liquid from the dispensing container to the dispensing unit, and
the dispensing unit comprises a dispensing opening, from which the liquid can be dispensed into a vessel,
a filling level capturing unit for automatically capturing a surface of a liquid filled into the vessel.

20. Method for producing and dispensing a drink by a drink producing apparatus comprising the following steps of:
providing a dispensing container, which is formed for receiving a liquid addable to a drink by the drink producing apparatus,
providing a dispensing unit of the drink producing apparatus,
connecting the dispensing container to the dispensing unit for leading the liquid from the dispensing container to the dispensing unit,
placing a vessel on a receiving device of the drink producing apparatus,
capturing the vessel and determining at least one geometric parameter of the vessel,
dispensing a jet of the at least one liquid from a dispensing opening of the dispensing unit into the vessel.

21. Method according to claim 20, wherein at least two optical signals are generated in different height positions as light barriers for capturing the at least one geometric parameter.

22. Method according to claim 20, wherein at least two light barriers are generated in the same height position and spaced and parallel to each other in this height position for capturing the at least one geometric parameter in horizontal direction.

23. Method according to claim 20, wherein the vessel is taken into a placing position on the receiving device and is moved upwards starting from the placing position, and the capture of the vessel for determining the at least one geometric parameter is performed during the upwards movement.

24. Method according to claim 23, wherein upon the upwards movement of the vessel an upper border of the vessel traverses a light barrier of the vessel capturing unit uppermost in vertical direction and the vessel is further moved upwards by a defined vertical path after traversing the uppermost light barrier.

25. Method according to claim 20, wherein the at least one determined geometric parameter of the vessel is compared to a stored reference parameter and a shape of the vessel is determined depending on the comparison.

26. Method according to claim 20, wherein a receiving volume of the vessel is determined depending on the at least one determined geometric parameter of the vessel.

27. Method according to claim 21, wherein in filling the liquid into the vessel, the surface of the liquid already filled into the vessel is captured as the filling level.

28. Method according to claim 27, wherein the filling level is captured by the light barriers.

29. Method according to claim 28, wherein the dispensing of the liquid from the dispensing opening is automatically stopped when the filling level is captured by the uppermost light barrier.

30. Method according to claim 20, wherein in filling the liquid into the vessel, a surface of the liquid already filled into the vessel is determined as the filling level of the drink in the vessel and thereto a capturing signal is emitted to the surface of the liquid in the vessel at an angle to the axis of the jet of the liquid dispensed from the dispensing opening and the signal reflected on the surface is captured, wherein the filling level is determined depending on a place of incidence of the reflected signal at a receiver.
